(19) United States
(12) Patent Application Publication
(10) Pub. No.: US 2002/0056338 A1
(43) Pub. Date: May 16, 2002

(54) Cost effective and reliable automatic balancer for high speed applications

(76) Inventors: Stefan Olausson, Goteberg (SE); Anders Hagglund, Trollhattan (SE); Paul Wierzba, Calgary (CA)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/897,456

(22) Filed: Jul. 3, 2001

Related U.S. Application Data
(60) Provisional application No. 60/216,152, filed on Jul. 3, 2000.

(51) Int. Cl. F16F 15/22

(52) U.S. Cl. 74/573 R

(57) ABSTRACT

A cost effective and reliable automatic balancer for high speed applications reduces the impact of unbalanced rotary tools and other devices. The automatic balancer provides a housing within which is defined a race. The race is accessible through a lid which removably covers one side of the race, allowing access to this cavity. A curved section of the race has a radius somewhat greater than that of a spherical compensating mass. The osculation region, where the compensating mass and curved section of the race meet, is carefully sized so that the surface area of contact is sufficient to prevent undue wear on the race, yet not so extensive at to result in excessive frictional contact between the compensating mass and the race. A lubricating fluid, filling at least a portion of the race, passes the compensating mass easily, due to the relative sizes of the compensating mass, the cross-sectional area of the race and the size of the osculation.

This application claims priority under 35 U.S.C. §§ 119 to U.S. provisional application Ser. No. 60/216,152, filed on Jul. 3, 2000; the entire content of which is hereby incorporated by reference.

### BACKGROUND OF THE INVENTION

1. Technical Field to Which the Invention Belongs

The present invention relates to a cost effective and reliable automatic balancer for high speed applications capable of reducing wear between a compensating weight and a race.

2. Discussion of the Related Art

The need to balance high speed rotary machines, such as angle grinders and other hand tools, centrifuges, optical disc drives, etc. is well-known. In general, the need to balance high speed rotary machines is related to the benefit of reduced vibration. Vibration is undesirable due to the stress and damage to both the operator and the machine itself. Dynamic balancing of these high speed rotary machines has been accomplished using automatic balancers that have a compensating weight that settles in a position around a rotating shaft where additional weight is needed to balance the rotation. A collar surrounds the shaft and contains a race that holds the compensating weight. High speed rotation imparts a large centrifugal force on the compensating weight. The compensating weight then transfers this force to the race. When the centrifugal force is great enough, the surface of the race is deformed, preventing free movement of the compensating weight in the race.

A number of techniques have been proposed to counteract the unknown or changing unbalances in rotating machines. These techniques are based on the concept of automatic balancing. Structures implementing this concept include an apparatus mounted on the rotating member. The apparatus defines an annular cavity containing a plurality of movable masses and a damping fluid. In a typical application, the movable masses are steel balls or similar such device, and the damping fluid is a lubricant. At sufficient rotational speeds, the movable masses position themselves in a manner that counteracts the unbalance of the rotating member.

One such apparatus is disclosed in U.S. Pat. No. 3,733,923 issued to Goodrich et al. The Goodrich '923 reference discloses an automatic balancer having an annular race formed of a bent metallic tube. A plurality of freely movable spherical counterbalance weights and a lubricating fluid are disposed within the tube.

U.S. Pat. No. 4,905,776 issued to Baynet et al. discloses an assembly having a plurality of annular races or grooves defined in the outer periphery of the rotating member along its axis of rotation. The apparatus further includes a number of freely movable balls or rollers disposed in each of the annular grooves. During rotation, the balls or rollers position themselves to compensate for any unbalance.

U.S. Pat. No. 4,674,356 issued to Kilgore discloses a device intended for balancing crankshafts including an annular groove containing a plurality of movable weights and a damping fluid. The device contains a center hole and keyway to attach to the shaft. First and second counterbalancing devices may be mounted on first and second ends of the shaft to counteract unbalanced forces.

U.S. Pat. No. 5,768,951 issued to Hannah et al. discloses a variety of devices for counteracting unbalanced forces in rotating members. The reference discloses an apparatus within which are defined a plurality of annular grooves disposed axially and longitudinally. A plurality of freely movable weights of different sizes and a plurality of damping fluids of different viscosities are disclosed.

Unfortunately, the known references are not well-suited for high-speed applications. It is well-known that as the speeds of the rotating members increase, the radially outward components of the centrifugal forces which the movable masses impart on the outer faces of the annular grooves or races increase. This force may lead to permanent damage to the races. A failure mode known as “brinelling” is caused by high contact stresses between the face of the race and the movable masses. This force and associated friction, in turn, would impede the free movement of the compensating masses and prevent the apparatus from functioning properly.

One solution for such a problem would be to provide hardened races, or alternatively to provide inserts made of hardened material able to withstand the forces between the compensating masses and the race surfaces.

Utilization of a hardened race is well known, and is referred to by such references as EP 0857266, disclosing an automatic balancing application, or U.S. Pat. No. 5,613,408 issued to Taylor et al. Unfortunately, such devices are expensive and difficult to manufacture. Typically, hardened races or inserts would require precision machining and polishing for proper operation. A number of costly manufacturing steps would therefore be added to the production of such units. These costs would be significant with respect to the cost of the entire balancer.

U.S. Pat. No. 3,969,688 issued to Goodrich et al. discloses a structure which attempts to provide an alternative to hardened races in high-speed applications. An apparatus is disclosed which defines an annular groove built into the peripheral wall of a race. The peripheral wall is semi-circular in cross-section. The curvature of the wall is closely matched to the radius of the spherical compensating masses contained within the device, which travel within the race. The additional area of surface contact, between the balls and the wall of the race, reduces the level of stress on any given location on the race. However, the overall result is greater frictional contact between the ball and the race, which tends to impede the free movement of the masses. This tendency is exacerbated by the presence of lubricating fluids, due to the greater influence of surface tension and capillary action. Therefore, while the race is better protected, the balls are less able to move freely to the required location, preventing the correction of rotary unbalances.

In a typical hand tool application, the vibration of the rotary portion of the tool results in vibration of the handle and therefore the operator's hand and arm. Sustained exposure to vibrations from a power hand tool can result in discomfort and impact negatively on the operator's well being. Such exposure also has an economic impact, in that down time is increased, as well as sick time, and medical expenses. On some high speed rotating machines, such as hand-held grinders, the unbalances tend to increase with time during use. As the grinding operation is performed, the grinding disk wears. The wear is typically non-uniform, which leads to increased vibration due to a greater loss of abrasive material from the grinding disk in some areas. The non-uniform wear rate accelerates the entire problem of unbalance of the grinding disk which intensifies the need for a cost effective and reliable automatic balancer.

For the foregoing reasons, there is a need for a cost effective and reliable automatic balancer for high speed applications that can reduce the stress and associated wear to the race, while also reducing the frictional contact between the balls and the race in a manner that results in greater responsiveness of the balancer in correcting the unbalance of a rotating member to which it is attached.

### OBJECTS AND SUMMARY OF THE INVENTION

A novel cost effective and reliable automatic balancer for high speed applications is disclosed that reduces the wear between the compensating masses and the race in which they move. The balancer does not require expensive hardening techniques, and is produced from materials that are readily machinable. The balancer also results in greater responsiveness by the compensating masses due to reduced frictional contact, and therefore better corrects for unbalances present in a rotating member to which the balancer is attached.

The automatic balancer of the present invention is particularly useful for reducing vibration in power hand tools.

Therefore, an object of the subject invention is to provide a novel, cost effective and reliable automatic balancer for high speed applications that is effective in removing unbalance from rotating members.

Another object of the subject invention is to provide a novel cost effective and reliable automatic balancer for high speed applications which is durable and provides a long life cycle.

Another object of the subject invention is to provide a novel cost effective and reliable automatic balancer for high speed applications wherein both the compensating masses and the race that are more easily manufactured than prior balancers, and which may be constructed from a variety of materials, and in particular which does not require hardened materials for proper operation.

Another object of the subject invention is increase the surface area of contact between the compensating mass and the race. By increasing the surface area of contact between the compensating mass and the race, non-hardened materials can be used for the compensating mass and race in high speed automatic balancers. Non-hardened materials are easier to machine which reduces the cost of producing the automatic balancer of the subject invention.

Another object of the subject invention is to allow relatively free movement of the compensating masses within the race by making the radius of the compensating masses in osculation with the radius of a track in the race. This permits a lubricating liquid within the race to flow relatively freely around the compensating masses. Free movement of the compensating masses allows them to move into a required position for balancing rotation in high speed applications.

Another object of the subject invention to provide an novel cost effective and reliable balancer for applications traditionally regarded as low-speed by utilizing the features described herein.

In some high speed applications where the imbalances are low and thus only small amounts of imbalance compensation are required, the presence of a lubricating and dampening fluid can be detrimental to the proper operation of a balancer, because the fluid can inhibit proper (re-)positioning of the compensating masses. Therefore, another object of the subject invention is to provide a high speed automatic balancer which requires no lubricating and dampening fluid.

According to a first exemplary embodiment, an automatic balancer for balancing a mass rotating about an axis, the automatic balancer having a cylindrical collar rotatable about the axis. At least two compensating masses are provided, the at least two compensating masses being substantially spherical. A race is included and is disposed within the cylindrical collar and concentric with the axis, the race configured and arranged to receive the at least two compensating masses, as well as a running track disposed in a perimeter edge of the race, the perimeter edge of the race being substantially parallel with the axis, wherein the running track has a curvature in osculation with a radius of the at least two compensating masses and a ratio of the radius of the at least two compensating masses divided by a radius of the curvature of the running track is greater than zero and less than one.

The running track of the automatic balancer preferably has a width less than twice the radius of the compensating masses. The width of the running track is typically 10% to 50% of twice the radius of the at least two compensating masses. The ratio of the radius of the at least two compensating masses divided by a radius of the curvature of the running track is greater than zero and less than one, and typically between 0.3 and 0.9. The automatic balancer preferably further includes an enclosing member for enclosing the at least one compensating mass within the race. The automatic balancer further includes a lubricating fluid within at least part of the race. The collar of the automatic balancer is made of one of a plastic, a metallic cast, and a steel alloy, and the at least one compensating mass is made of one of a plastic, a ceramic, a tungsten carbide, a hardened steel, and a steel.

According to a second exemplary embodiment, an automatic balancer for balancing a mass rotating about an axis, has a cylindrical collar rotatable about the axis. At least two compensating masses are provided, the compensating masses each being substantially spherical. A race is included and is disposed within the cylindrical collar and concentric with the axis, the race configured and arranged to receive the at least two compensating masses. An enclosing member is configured and arranged to enclose the race and the at least two compensating masses. A lubricating fluid is provided in at least a portion of the enclosed race. A running track is disposed in a perimeter edge of the race, the perimeter edge of the race being substantially parallel with the axis, wherein the running track has a curvature in osculation with a radius of the at least two compensating masses and a ratio of the radius of the at least two compensating masses divided by a radius of the curvature of the running track is greater than zero and less than one, wherein the osculation provides greater surface contact between the at least two compensating masses and the running track of the race while allowing substantially free flow of the lubricating liquid around the at least two compensating masses.

The running track of the automatic balancer preferably has a width less than twice the radius of the at least two compensating masses. The width of the running track is typically 10% to 50% of twice the radius of the at least two compensating masses. The ratio of the radius of the at least two compensating masses divided by a radius of the curvature of the running track is greater than zero and less than one, and typically between 0.3 and 0.9. The automatic balancer preferably further includes an enclosing member for enclosing the at least two compensating masses within the race. The automatic balancer further includes a lubricating fluid within at least part of the race. The collar of the automatic balancer is made of one of a plastic, a metallic cast, and a steel alloy, and the at least two compensating masses are made of one of a plastic, a ceramic, a tungsten carbide, a hardened steel, and a steel.

According to a third exemplary embodiment, an automatic balancer for balancing a mass rotating about an axis has a cylindrical collar positionable about the axis. At least two compensating masses are included, the at least two compensating masses being substantially spherical. At least two races are provided, disposed within the cylindrical collar and concentric with the axis, the at least two races configured and arranged to receive the at least two compensating masses. A running track disposed in a perimeter edge of each of the at least two races, the perimeter edge of the at least two races being substantially parallel with the axis, wherein the running track has a curvature in osculation with a radius of one of the at least two compensating masses and a ratio of the radius of the one of the at least two compensating masses divided by a radius of the curvature of the running track is greater than zero and less than one.

The automatic balancer preferably further includes at least two enclosing members configured and arranged to enclose each of the at least two races and the at least two compensating masses. The automatic balancer further includes a lubricating fluid in at least a portion of each or the at least two enclosed races. The at least two enclosing members are detachably connected to the cylindrical collar. The automatic balancer also preferably includes a lubricating fluid in at least a portion of each of the at least two races. One of the at least two races has a greater circumference than a circumference of another of the at least two races. The running track of the one of the at least two races having a greater circumference has a ratio of the radius of the one of the at least two compensating masses divided by a radius of the curvature of the running track of the one of the at least two races having a greater circumference that is greater than the ratio of the radius of another one of the at least two compensating masses divided by a radius of the curvature of the running track the another of the at least two races.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWING FIGURES

The invention of the present application will now be described in more detail with reference to preferred embodiments of the apparatus and method, given only by way of example, and with reference to the accompanying drawings, in which:

FIG. 1 is an isometric view of an exemplary version of the cost effective and reliable automatic balancer for high speed applications of the invention, illustrating an application of the balancer which is attached to a hand tool having a grinding disk.

FIG. 2 is an enlarged view of the balancing device and tool of FIG. 1, additionally having an isometric view of a version the automatic balancer of the invention.

FIG. 3 illustrates a cross-sectional view of a preferred version of the cost effective and reliable automatic balancer for high speed applications of the invention.

FIG. 4 is a sectional diagrammatic view of a so-called wide osculation.

FIG. 5 is a sectional diagrammatic view of a so-called narrow osculation.

FIG. 6 is a cross-sectional drawing of an alternate embodiment according to the present invention.

### DESCRIPTION OF THE PREFERRED EMBODIMENTS

Referring to the drawing figures, like reference numerals designate identical or corresponding elements throughout the several figures.

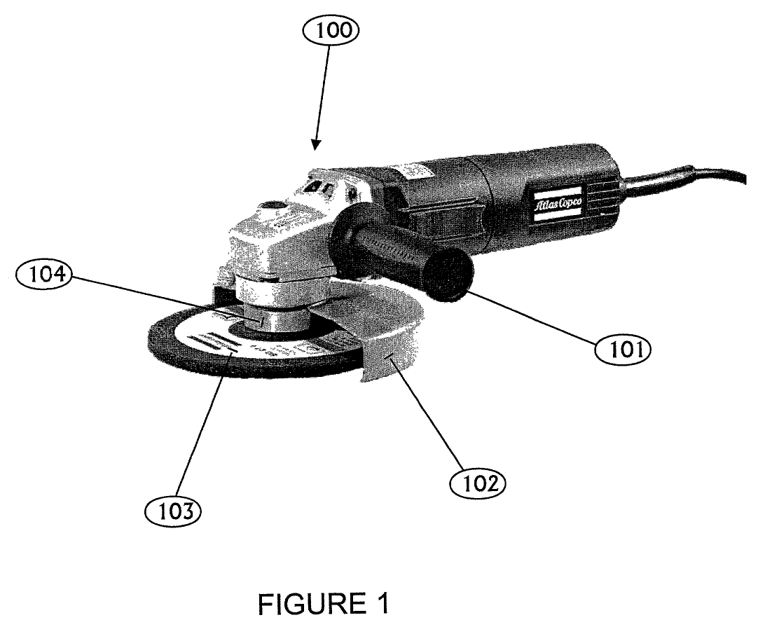

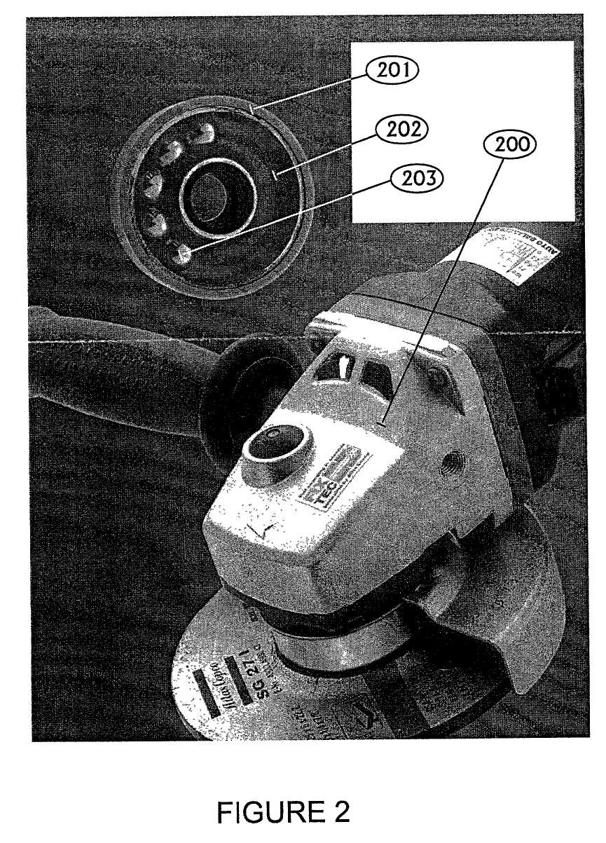

An automatic balancer according to the present invention is contained within a housing, which is adapted for attachment to a tool having a rotating member which is unbalanced during high speed rotation. An example of such a tool is seen in FIGS. 1 and 2, where a grinder is fitted with a version of the automatic balancer of the invention. However, any tool or apparatus having unbalanced rotary motion could alternatively be fitted with a version of the automatic balancer.

In the context of the present invention, the term “high speed” is used in a relative sense, as will be readily understood by those of ordinary skill in the art. Accordingly, certain rotary machines are typically operated at relatively high speeds, such as grinders at 7000-16000 rpm, which can be termed “high speed” for grinders, while industrial washing machines operated at 700 rpm are considered to be run at “high speed”. Thus, those of skill in the art will appreciate that it is the forces generated by the rotational speed of the rotary machine, and the design criteria which are driven by at least these forces, which are implicated with the use of the term “high speed.”

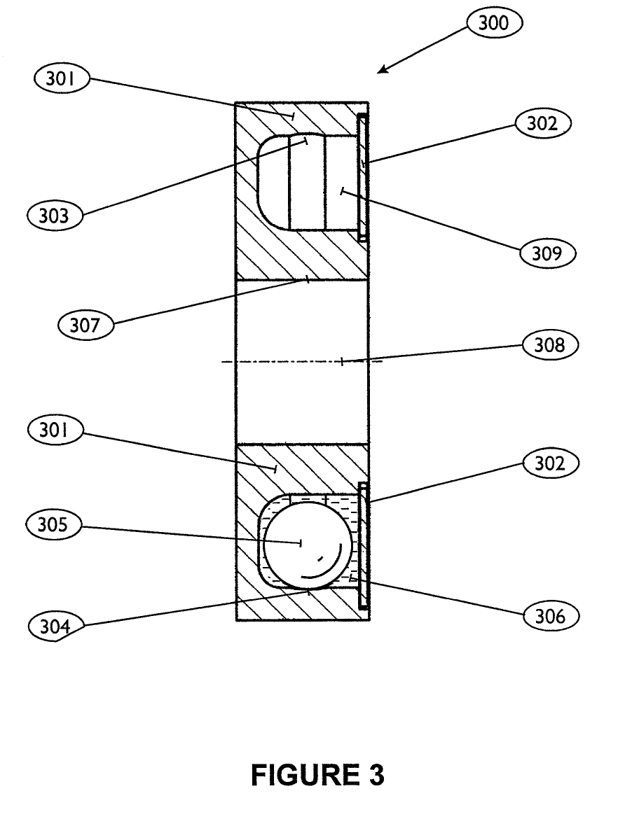

Referring generally, to FIGS. 1 through 3, a cost effective and reliable automatic balancer for high speed applications constructed in accordance with the principles of the invention is seen. Referring to FIG. 1, a tool 100 having a handle 101 is of a rotary nature, having a grinding disk 103 with safety guard 102. A balancer 104 is mounted concentrically with the drive shaft of the disk. As seen in a preferred embodiment of FIG. 3, the high speed balancer 300 includes a housing or collar 301 within which is defined a race 309. A center opening defined in the housing 301 is concentric with an axis of rotation 308. In operation, an annular face 307 or other surface of the center opening is fitted about a spindle, rotor or other structure of the grinder or similar tool in a manner which causes the axis 308 to align with the axis of rotation of the rotational part of the tool, such as the grinding disk 103 seen in FIG. 1.

Continuing to refer to FIG. 3, the housing defines the annular race 309. The race is accessible through a lid 302 that permanently or removably covers one side of the race, allowing access to this cavity. Alternatively, the housing could include mirror image halves, each half defining a portion of the race 309, which would eliminate the need for a lid. The race 309 provides an annular track or section 303 having a pre-designed curvature which has a radius chosen with regard to the compensating mass 305. As a result, the two curved surfaces, i.e., those of the compensating mass 305 and the track 303, form an osculation 304.

The size of the section or track 303 having the curvature results in an osculation region 304, i.e., a region wherein two curved surfaces meet. The osculation precisely controls the balance between (1) the degree of surface area contact between the race and the compensating mass, (2) the hardness to which the race must be manufactured, and (3) the friction between the mass and the race which governs the ability of the compensating masses to move with the speed and direction which results in the correction of unbalances in the rotating member. As seen in FIG. 3, the preferred osculation 304 does not extend over a substantial portion of the compensating mass 305. As a result, lubricating fluid 306 is able to pass around the compensating mass as it moves. However, the osculation 304 does extend over sufficient area of the compensating mass so that the curved section or track 303 does not have to be hardened to the extent required by the prior art. Therefore, the housing is less expensively manufactured.

As seen in FIG. 3, a compensating mass 305 is typically a spherical shape and can be made of a variety of materials such as steel, hardened steel, tungsten carbide, ceramic, or plastic. In the embodiment of the subject invention illustrated in FIG. 2, the compensating masses 203 are ball bearings or very similar elements, and are sized for rotation in the raceway 202 defined in the housing 201. The compensating masses are positioned within the race 202 defined in the housing 201. In operation, the compensating masses move against the curved track defined within the race.

As seen in FIG. 3, lubricating fluid 306 occupies at least a portion of the race 309. The lubricating fluid reduces the friction between the compensating mass 305 and the race defined within the housing. The size of the osculation region 304, the magnitude of the osculation within the osculation region 304, the surface area of contact between the compensating masses and the curved section of track 303, the cross-sectional area of the race, and the viscosity of the lubrication fluid all influence the movement of the compensating masses. In the structure illustrated in FIG. 3, the lubricating fluid is able to move past the compensating masses as they move within the race without undue friction which would result in a failure to damp the imbalance of the rotary motion.

Fluid 306 serves a number of important functions. It can provide a certain amount of lubrication for the movement of compensating masses thus reducing friction between the race and the compensating masses. It initiates the movement of the compensating masses when the rotation of the rotating body starts and stabilizes the compensating masses in the position opposite to imbalance when a rotating condition enabling such balancing action occurs. In fact, in most applications, without the stabilizing effect of the balancing fluid, the compensating masses may never achieve a stable counter-balancing position.

In some applications, however, the presence of dampening fluid is detrimental to the performance of the balancer, and is therefore more preferably excluded. This is particularly true in applications which involve small amounts of imbalance, whereby, the compensating masses are small. In such cases the properties of surface tension and adhesion of the damping fluid can cause the compensating masses to adhere and lump together and prevent them from positioning themselves so as to counteract the imbalance. Specifically, it has been found that for compensating masses smaller than 3 millimeters in diameter, their proper movement is already adversely affected by the typically available fluids. In cases such as this, it is desirable not to have any damping fluid. In the absence of the dampening fluid, the stabilizing effect on the compensating masses is achieved by utilizing narrow osculations. Here, the osculation is so chosen so as to provide the degree of rolling resistance which is sufficiently high to provide the stabilizing action on the compensating masses but not high enough so as to adversely affect the performance of the balancer.

Therefore, a balancer which requires no dampening or lubricating fluid is also as aspect of the present invention. As the balancer passes through the critical speed, there has to be a mechanism which provides a stabilizing action on the balancer masses or balls. This is typically accomplished with a dampening fluid. In some applications, particularly those which require very small balls such as, say, a CD-ROM drive, a dampening fluid cannot be used since the surface tension and adhesion, even for very light fluids such as alcohols or the shortest chain silicon oil, are dominant and the balancers can not achieve a good performance. For applications such as these, the balancers must run dry. Providing the race(s) with a narrow osculation with some added rolling resistance also can be used, as well as combinations thereof.

Some example of dampening fluids include organic and mineral oils. These have good lubricating properties and generally low surface tension in the range of 35 to 40 dynes/cm. In contrast, water has a surface tension of about 72 dynes/cm. It is generally beneficial to have a dampening fluid characterized by low surface tension and good lubricating properties. The main disadvantage of mineral and organic oils is that its viscosity changes greatly with temperature. At very cold temperatures these oils tend to become very viscous, while at high temperatures the viscosity may become too low. For applications where temperatures change considerably, the so-called silicone oils are preferred. These are characterized by, among other things, enhanced temperature stability. Some examples of silicon oils include, but are not limited to: trifluropropyl siloxydimetyl siloxan (low friction and high temperature); methyltrifluoro propylcyclic trimer (low viscosity, typically used as a primer); Hexamethyldisiloxan, suitable for applications requiring low viscosities; Baysilone Fluids P (Bayer), based on methylphenyl siloxanes, offering better lubrication in addition to thermal stability (Baysilone PN 5 to 1000); Baysilone Fluids M, based on dimethyl siloxanes, offering better thermal stability with somewhat reduced lubrication properties (Baysilone M3 to M1000000).

Silicon oils are also typically characterized by relatively low surface tension. This is desirable in systems that utilize relatively small ball sizes, where the effect of surface tension of common mineral oils can result in poor performance of the balances. Excessive surface tension of the damping fluid tends to cause the balls to adhere to one another and bunch together and thus prevents the balls from moving to the proper locations so as to counteract the imbalance. Another advantage of using the silicone oils is that the surface tension is largely independent of the viscosity of the fluid. Therefore, a wide range of viscosities can be chosen to provide the required stabilizing damping on the balls without the adverse effect of the surface tension. As will be readily apparent to those of skill in the art, other fluids are suitable in the present invention, which have the requisite characteristics, described above.

Some nonlimiting examples of surface tension properties are presented below:

Dimethyl silicones have low surface tension values largely independent of viscosity (about 21 dynes/cm @ 25° C. over 20 to 100.000 cSt);

Phenyl-containing fluids have slightly higher surface tension values (about 24 to 25 dynes/cm @ 25° C.);

The surface tension of organic fluids is typically in the range 35 to 40 dynes/cm. For water, 72 dynes/cm.

In a typical application, as seen in FIG. 2, a grinder 200 includes a rotary grinding wheel having an unbalance at high speeds. The automatic balancing unit attached to the grinder includes a housing 201 which defines a race 202. By way of example and not of limitation, five compensating masses 203 are carried by the race. A curved section 303 (see FIG. 3) of the race typically has a radius somewhat greater than that of a spherical compensating mass 305. The osculation region 304, where the compensating mass and curved section of the race are in contact, is carefully sized so that under the operating conditions the surface area of contact is sufficient to prevent undue wear on the race, yet not so extensive as to result in excessive frictional contact between the compensating mass and the race. The lubricating fluid 306, filling at least a portion of the race, passes the compensating mass easily, due to the relative sizes of the compensating mass, the cross-sectional area of the race, and the size of the osculation region 304.

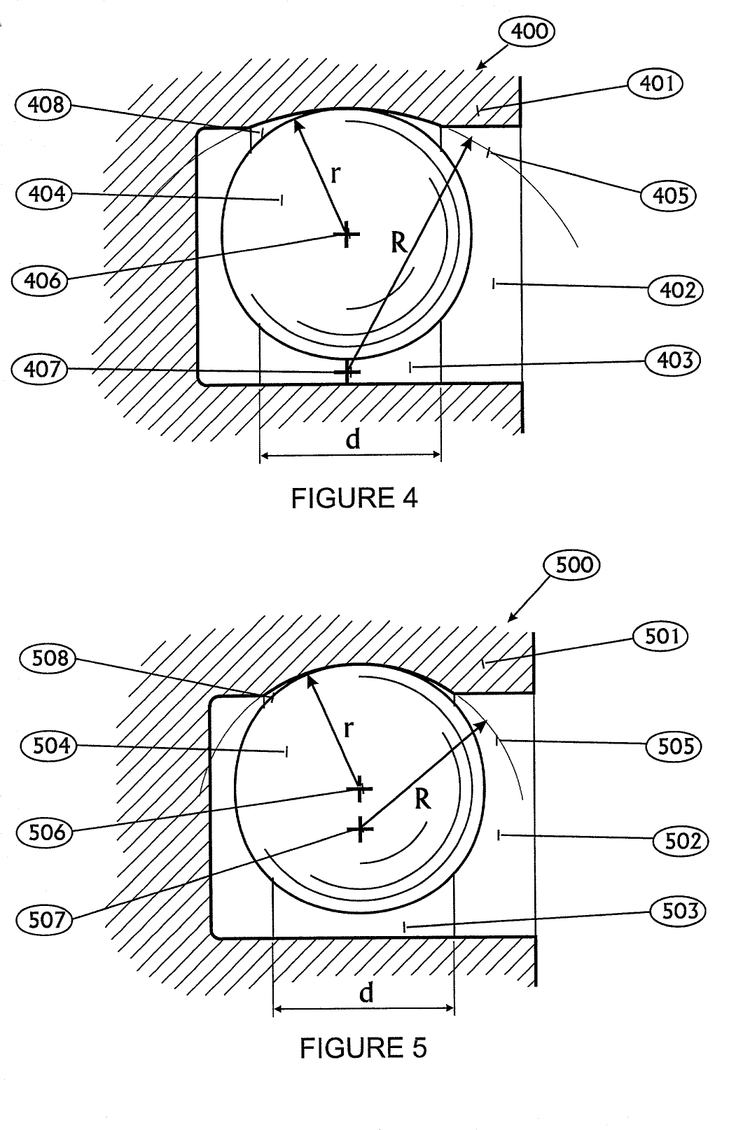

For greater clarity, referring to FIGS. 4 and 5, the osculation region 408 is defined by the transverse race curvature 405 having a radius of curvature R, and the curvature of the compensating mass 404 having a radius r. Similarly, the osculation region 508 is defined by the transverse race curvature 505 having a radius of curvature R, and the curvature of the compensating mass 504 having a radius r. The size of the osculation region is preferably expressed as a percentage of the compensating mass diameter 2r and is equal to d/(2r)×100%, wherein d is the axial width of the regions 408 or 508. That is,

d=X(2r),

wherein X is expressed as a (dimensionless) percentage. According to certain aspects of the present invention, X is between about 10% and about 50%, and more preferably between about 25 % and about 35 %.

The ratio between the compensating mass radius r and the curvature R of the running track, r/R, is referred to as the magnitude of osculation. In practice, the magnitude of osculation is chosen between about 0 and about 1, with values close to 0 referred as wide osculations and values close to 1 as narrow osculations. According to other aspects of the present invention, r/R is between about 0.3 and about 0.9. According to yet further aspects of the present invention, when there is no lubricating/dampening fluid used in the race(s), r/R can be about 0.95.

Referring to FIG. 4, a diagrammatic representation 400 of a relatively wide osculation is shown. The radius R of curvature 405 of the running track 403 of race 402 formed in the housing 401, and is substantially greater than the radius r of the compensating mass 404. Correspondingly, the center 407 of the curvature 405 is located at a considerable distance away from the center 406 of the compensating mass 404. In the limited case, when the running track does not possess a transverse curvature and the magnitude of osculation is equal to 0, the osculation is referred to as open.

Further, referring to FIG. 5, a diagrammatic representation 500 of a relatively narrow osculation is shown. The radius R of curvature 505 of the running track 503 of race 502 formed in the housing 501, is not much greater than the radius r of the compensating mass 504. Correspondingly, the center 507 of the curvature 505 is close to the center 506 of the compensating mass 504. In the limited case when the curvature of the running track is equal to the radius of the ball and thus, the magnitude of the osculation is equal to 1, it is said that the osculation is closed.

The magnitude of the osculation and the size of the osculation region are carefully chosen on the basis of the balancer geometry, operating speed and conditions, and compensating mass and race materials so as to optimize the surface area of contact between the ball and race. The starting point for the selection is the performance of the balancer in terms of the residual vibration level. In practical terms, the balancer will never completely remove an out-of-balance condition, and due to effects of race deformation and rolling resistance, the residual imbalance will likely result. The performance criteria for the balancer identifies the resultant residual vibration. From this, the maximum allowed rolling resistance is determined. The rolling resistance and the residual vibration are related in accordance with:

ε=Cμ_{R}ρ

where, ε is the residual vibration level, μ_{R} is the rolling resistance coefficient, ρ represent the size of the race and is equal to the distance from the center of rotation to the center of the ball, and C is a constant.

It has been found that C preferably is between 1.5 and 2 (units of length, e.g., mm). Once the rolling resistance coefficient μ_{R} is defined, a selection is made for the race material and the size and magnitude of the osculation given the rotational speeds of the machine and the size of the compensating masses. The osculations for the race(s) should be designed so that brinelling for each of the races is avoided, that is that the maximum contact stresses are below those which cause the yielding of the material.

Such a selection is done on the basis of mathematical theories, such as Hertzian theory, for example, as well as the empirical data. For example, it has been observed that softer materials such as plastics or certain metallic casts require narrower osculations, while harder materials such as steel alloys show better performance with wider osculations. Furthermore, it has been observed that with all else being equal, higher rotational speeds and higher centrifugal forces generally require narrower osculations. Specifically, for the high speed grinder application of FIG. 1, an osculation magnitude of 0.794 and the size of the osculation region of 25 % were chosen for the system having a steel race with surface hardness of 310 HB and hardened steel compensating masses. In this example, it was desirable to achieve the residual vibration levels below 30 micrometers which necessitated the rolling resistance coefficient to be below 0.0007 at speeds of 7000 rpm. Typically, the size of the osculation region is in the range of 25% to 35% but it could extend beyond this range, according to yet other aspects of the present invention. FIGS. 4 and 5 show the sizes of the osculations being of a much higher proportion for clarity in the drawings, i.e., are not necessarily drawn to scale for ease of understanding.

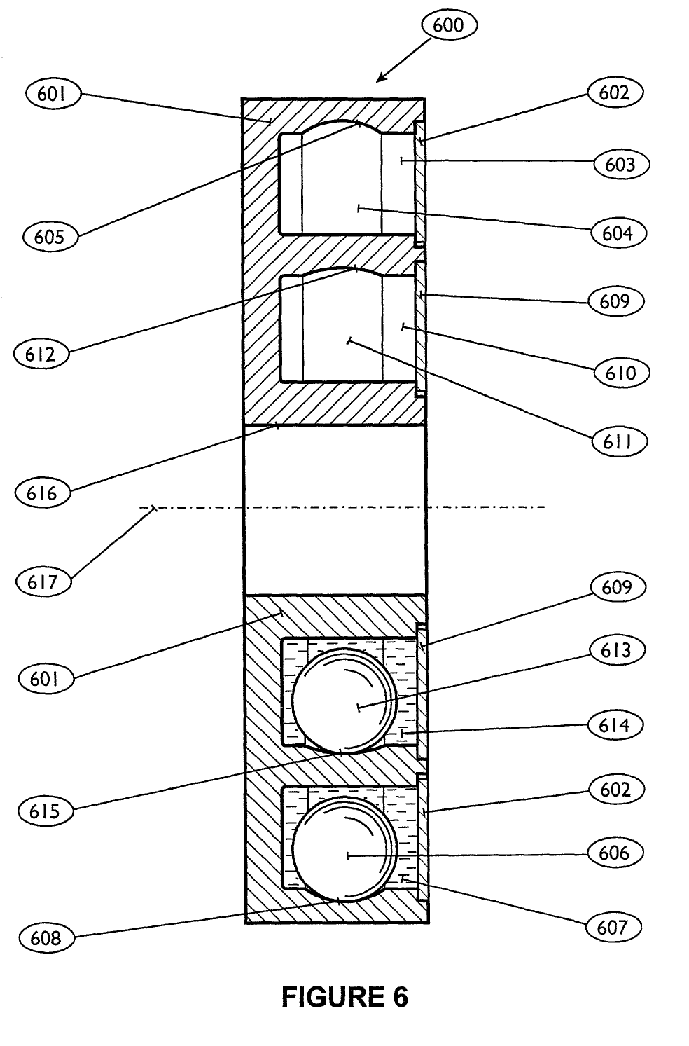

Referring to FIG. 6, an alternate embodiment for the cost effective and reliable balancer for high-speed application is shown. The balancer 600 comprises a housing 601 within which are defined two races 603 and 610. Removable or permanent lids 602 and 609 seal the race cavities 603 and 610. A first plurality of compensating masses 606 is disposed inside the first annular race 603. A second plurality of compensating masses 613 is disposed in the second race 610. The first race 603 provides a section 604 with the first pre-designed curvature 605. The second race 610 provides a section 611 with the second pre-designed curvature 612. The curved section 604 of the first race 603 forms a first osculation region 608 with the compensating mass 606. The curved section 611 of the second race 610 forms a second osculation region 615 with the compensating mass 613.

A first lubricating/damping fluid 607 is disposed in the first race cavity 603. A second lubricating/damping fluid 614 is disposed in the second race cavity 610; the first and second fluids 607, 614 can be the same or different fluids. The balancer 600 also includes an annular face 616 for attachment to, and centering on, a rotatable spindle or a shaft along the axis of rotation 617. Typically, the curvature 605 of the outermost first race 603 is chosen so as to result in a higher magnitude of osculation 608 than that for the innermost race 610. This is because the compensating masses 606 of the outermost race 603 are subjected to higher centrifugal forces than the compensating masses 613 of the innermost race 610, and hence a narrowing of the osculation 608 is preferred, and may be required, for the race 603.

Referring further to FIG. 6, the alternate embodiment 600 shows the first plurality of compensating masses 606 as being substantially the same size as the second plurality of compensating masses 613. It should, however, be understood that depending on the particular application, operating-conditions, and geometrical constraints, a different size could be chosen for the second plurality of compensating masses. Also, the alternate embodiment 600 shows an apparatus having two concentric races 603 and 610 disposed coaxially relative to each other. It should be noted, however, that if needed a greater number of coaxial races can be utilized, and that such co-axial races can be disposed in axial or longitudinal manner, or any combination thereof. Furthermore, it should be understood that the different races with compensating masses disposed therein could have different osculation magnitudes, ranging from 0 to 1, and different sizes of osculation regions, ranging in proportion from 5% to in excess of 100% of the ball diameter. Also, different lubricating fluids can be disposed in different races.

For a system with a multitude of races, the particularly efficient design is the one for which the residual vibration levels as given by the equation are the same, that is:

μ₁ρ₁=μ₂ρ₂=μ₃ρ₃= . . . , etc.

since under this scenario, each race provides the same performance as measured by the residual vibration level. Alternately, if, given the materials involved, it is not possible to achieve such a situation, the osculations for each of the races should be designed so that brinelling for each of the races is avoided, that is that the maximum contact stresses are below those which cause the yielding of the material. It should also be noted that although the case of two races was shown, more then two races could be used.

To use the invention, the automatic balancer 300 (or 104, 400, 500, 600) is attached to a rotary tool or other source of unbalanced rotary motion. The axis of rotation 308 of the automatic balancer is aligned to be essentially coincident or collinear with the axis of rotation of the tool. The face 307 of the opening through which the axis is defined is sized to fit about the spindle, motor or other structure associated with the tool, in a manner that properly aligns the axis 308 with the rotor shaft of the motor of the tool.

During operation of the tool, the compensating masses 305 move through the race 309 in contact with the track 303. The lubricating fluid 306 flows freely around the compensating masses as they move.

The location, speed and direction of movement of the compensating masses, and their resulting inertial forces, tends to cancel the unbalancing forces inherent with the rotary motion of the tool or other source of rotary unbalance.

In operation, the osculation region 304, wherein the compensating masses contact the track 303 defined in the race 309, results in sufficient surface area to prevent excessive wear of the track 303 or other portions of the race. However, the surface area of contact is insufficient to result in excessive friction, which would result in an inability of the lubricating fluid 306 to freely flow around the compensating masses preventing the compensating masses from moving in a manner that cancel the unbalance of the rotary motion.

According to certain aspects of the present invention, the outer housings or collars can be formed of one of a plastic, a metallic cast, and a steel alloy. According to other aspects, the material out of which the running track is formed is softer than the material of the compensating masses which run in the track.

While some aspects of the present invention relate to balancing of hand held power tools, other aspects of the present invention relate to the balancing of other rotary machines. By way of example and not of limitation, other rotary machines with which the present invention can be used include pumps, rotating saws, disc drives (including optical and magnetic), centrifuges, washing machines, chain saws, separators, rotary combustion engines, turbines, industrial fans, and the like, and can be particularly useful in applications which involve high rotational speeds and the necessity of hardened races.

The foregoing description has described one aspect of the invention in terms of circular races; however, the present invention is not so limited. Balancers having races which are themselves, or portions of which, are other than circular, e.g., elliptical, parabolic, or other non-circular geometries, are also within the scope of the present invention.

While the subject invention has been illustrated and described in detail in the drawings and foregoing description, the same is to be considered as illustrative and not restrictive in character, it being understood that only the preferred exemplary embodiments have been shown and described and that all changes and modifications that come within the spirit of the invention are desired to be protected. Each of the aforementioned published documents is incorporated by reference in its entirety herein.

What is claimed is:

1. An automatic balancer for balancing a mass rotating about an axis, the automatic balancer comprising:
a cylindrical collar rotatable about the axis;
at least two compensating masses, the compensating masses being substantially spherical;
a race, disposed within the cylindrical collar and concentric with the axis, the race configured and arranged to receive the at least two compensating mass; and
a running track disposed in a perimeter edge of the race, the perimeter edge of the race being substantially parallel with the axis, wherein the running track has a curvature in osculation with a radius of the at least two compensating masses and a ratio of the radius of the at least two compensating masses divided by a radius of the curvature of the running track is greater than zero and less than one.

2. The automatic balancer of claim 1, wherein a width of the running track is less than twice the radius of the at least two compensating mass.

3. The automatic balancer of claim 1, wherein a width of the running track is a percentage of twice the radius of the at least two compensating masses in the range of 10% to 50%.

4. The automatic balancer of claim 1, wherein a width of the running track is a percentage of twice the radius of the at least two compensating masses in the range of 25% to 35%.

5. The automatic balancer of claim 1, wherein the ratio of the radius of the at least two compensating masses divided by a radius of the curvature of the running track is in a range of 0.7 and 0.95.

6. The automatic balancer of claim 1, further comprising an enclosing member configured and arranged to enclose the race and the at least two compensating mass.

7. The automatic balancer of claim 6, further comprising a lubricating fluid in at least a portion of the enclosed race.

8. The automatic balancer of claim 6, wherein the enclosing member is detachably connected to the cylindrical collar.

9. The automatic balancer of claim 1, further comprising a lubricating fluid in at least a portion of the race.

10. The automatic balancer of claim 1, wherein the cylindrical collar is made of a material selected from the group consisting of a plastic, a metallic cast, and a steel alloy and the compensating masses is made of one of a plastic, a ceramic, a tungsten carbide, a hardened steel, and a steel.

11. An automatic balancer for balancing a mass rotating about an axis, the automatic balancer comprising:
a cylindrical collar rotatable about the axis;
at least two compensating masses, the compensating masses being substantially spherical;
a race, disposed within the cylindrical collar and concentric with the axis, the race configured and arranged to receive the at least two compensating masses;
an enclosing member configured and arranged to enclose the race and the at least two compensating masses;
a lubricating fluid in at least a portion of the enclosed race; and
a running track disposed in a perimeter edge of the race, the perimeter edge of the race being substantially parallel with the axis, wherein the running track has a curvature in osculation with a radius of the at least two compensating masses and a ratio of the radius of the at least two compensating masses divided by a radius of the curvature of the running track is greater than zero and less than one, wherein the osculation provides greater surface contact between the at least two compensating masses and the running track of the race while allowing substantially free flow of the lubricating liquid around the at least two compensating mass.

12. The automatic balancer of claim 11, wherein a width of the running track is less than twice the radius of the at least two compensating mass.

13. The automatic balancer of claim 11, wherein a width of the running track is a percentage of twice the radius of the at least two compensating masses in the range of 10% to 50%.

14. The automatic balancer of claim 11, wherein a width of the running track is a percentage of twice the radius of the at least two compensating masses in the range of 25% to 35%.

15. The automatic balancer of claim 11, wherein the ratio of the radius of the at least two compensating masses divided by a radius of the curvature of the running track is in a range of 0.7 and 0.9.

16. An automatic balancer for balancing a mass rotating about an axis, the automatic balancer comprising:
a cylindrical collar positionable about the axis;
at least two compensating masses, the at least two compensating masses being substantially spherical;
at least two races disposed within the cylindrical collar and concentric with the axis, each of the at least two races receiving at least one of the at least two compensating masses; and
a running track disposed in a perimeter edge of each of the at least two races, the perimeter edge of the at least two races being substantially parallel with the axis, wherein the running track has a curvature in osculation with a radius of one of the at least two compensating masses and a ratio of the radius of the one of the at least two compensating masses divided by a radius of the curvature of the running track is greater than zero and less than one.

17. The automatic balancer of claim 16, further comprising at least two enclosing members configured and arranged to enclose each of the at least two races and the at least two compensating masses.

18. The automatic balancer of claim 17, further comprising a lubricating fluid in at least a portion of each or the at least two enclosed races.

19. The automatic balancer of claim 17, wherein the at least two enclosing members are detachably connected to the cylindrical collar.

20. The automatic balancer of claim 16, further comprising lubricating fluid in at least a portion of each of the at least two races.

21. The automatic balancer of claim 16, wherein one of the at least two races has a greater circumference than a circumference of another of the at least two races.

22. The automatic balancer of claim 21, further comprising at least two enclosing members configured and arranged to enclose each of the at least two races and the at least two compensating masses.

23. The automatic balancer of claim 22, further comprising lubricating fluid in at least a portion of each of the at least two enclosed races.

24. The automatic balancer of claim 22, wherein the at least two enclosing members are detachably connected to the cylindrical collar.

25. The automatic balancer of claim 21, further comprising lubricating fluid in at least a portion of each of the at least two races.

26. The automatic balancer of claim 21, wherein the running track of the one of the at least two races having a greater circumference has a ratio of the radius of the one of the at least two compensating masses divided by a radius of the curvature of the running track of the one of the at least two races having a greater circumference that is greater than the ratio of the radius of another one of the at least two compensating masses divided by a radius of the curvature of the running track the another of the at least two races.

27. The automatic balancer of claim 26, further comprising at least two enclosing members configured and arranged to enclose each of the at least two races and the at least two compensating masses.

28. The automatic balancer of claim 27, further comprising lubricating fluid in at least a portion of each or the at least two enclosed races.

29. The automatic balancer of claim 27, wherein the at least two enclosing members are detachably connected to the cylindrical collar.

30. The automatic balancer of claim 26, further comprising lubricating fluid in at least a portion of each of the at least two races.

31. An automatic balancer for balancing a mass rotating about an axis, the automatic balancer comprising:
a cylindrical collar positionable about the axis;
at least two compensating masses, each of the at least two compensating masses being substantially spherical and having different masses;
two races disposed within the cylindrical collar and concentric with the axis, each of the two races receiving at least one of the at least two compensating masses; and
a running track disposed in a perimeter edge of each of the two races, the perimeter edge of the at least two races being substantially parallel with the axis, each of the running tracks having a curvature different from the other running track;
wherein the curvatures of the running tracks are selected so that at least one of the following conditions are met for the two races:
(a) the contact areas between the running track and the at least two compensating masses are the same; or
(b) the contact stress between the running track and the at least two compensating masses are the same.

32. An automatic balancer for balancing a mass rotating about an axis, the
automatic balancer comprising:
a cylindrical collar positionable about the axis;
at least two compensating masses, each of the at least two compensating masses being substantially spherical and having different masses;
first and second races disposed within the cylindrical collar and concentric with the axis, each of the first and second races receiving at least one of the at least two compensating masses and having a rolling resistance with each compensating mass; and
a running track disposed in a perimeter edge of each of the first and second races, the perimeter edge of the at least two races being substantially parallel with the axis, each of the running tracks having a curvature different from the other running track,;
wherein the curvatures of the running tracks are selected so that the radius of the first race multiplied by the rolling resistance of the first race is equal to the radius of the second race multiplied by the rolling resistance of the second race.

33. The automatic balancer of claim 1, wherein the osculation, race radius, and materials of the compensating mass and running track are mutually selected so that the contact stresses between the compensating mass and the running track are below the brinelling stress for the material of the running track.

34. The automatic balancer of claim 1, wherein the osculation is selected so that the rolling resistance between the compensating mass and the running track are below a predetermined level.

35. The automatic balancer of claim 16, wherein the osculation, race radius, and materials of the compensating mass and running track are mutually selected so that the contact stresses between the compensating mass and the running track are below the brinelling stress for the material of the running track.

36. The automatic balancer of claim 16, wherein the osculation is selected so that the rolling resistance between the compensating mass and the running track are below a predetermined level.

37. The automatic balancer of claim 1, wherein the material of the running track is softer than the material of the at least two compensating masses.
